(19) United States
(12) Patent Application Publication
(10) Pub. No.: US 2026/0000994 A1
(43) Pub. Date: Jan. 1, 2026

(54) INTELLIGENT AGENT PLATFORM FOR VIDEO GAME TESTING

(71) Applicant: Microsoft Technology Licensing, LLC, Redmond, WA (US)

(72) Inventors: Christopher DAVIS, Portland, OR (US); Julia KAHNFELD, Zurich (CH); Logan Bruce JONES, Medford, OR (US); Yanjie HE, Burnaby (CA); Wenhe LI, Sunnyvale, CA (US); Ryan Allen BYINGTON, Bellingham, WA (US); Andrea TREVIÑO GAVITO, Boston, MA (US); Haiyan ZHANG, Sammamish, WA (US); Chuyang KE, Redmond, WA (US); Anushka RAY, Redmond, WA (US)

(21) Appl. No.: 18/755,222

(22) Filed: Jun. 26, 2024

(51) Int. Cl. A63F 13/73

(52) U.S. Cl. CPC A63F 13/73

(57) ABSTRACT

A computing system executing an intelligent agent application is provided. The intelligent agent application facilitates configuration and deployment of an intelligent agent to perform certain acts related to video game testing. The intelligent agent application may configure and deploy an intelligent agent based upon an intelligent agent deployment request comprising one or more tasks to be performed by an intelligent agent. The intelligent agent application causes an intelligent agent to interact with a testing computing system executing a video game application and perform the one or more tasks. The intelligent agent captures testing data indicative of the interaction with the video game application. The testing data is optionally enhanced and stored for further analysis.

### BACKGROUND

Video game development is a complex and labor-intensive process which relies upon rigorous testing to refine various aspects of a game before the game is released to the public. Testing the game is necessary to uncover game anomalies or “bugs” which negatively impact the gameplay experience. Bugs can also cause diminished performance of the computing system executing the game which further negatively impacts the gameplay experience. Conventionally, game developers rely upon human testers to play a game and report bugs as they are encountered during gameplay. Certain bugs are difficult to discover and may occur only when certain conditions are met. The bugs may not be readily detectable through review of the source code of a video game application and may only be reproducible during certain gameplay conditions. Substantial resources are required to collect observational testing data through repetitive tester gameplay and extrapolate where and under what condition the bug occurs and how to fix or mitigate the bug. Even a large team of testers playing a game for many hours may fail to uncover certain bugs.

Video game developers also use automated tools to perform game testing. Conventionally, these tools are designed specifically for the game being tested and run inside an instance of the video game application. For example, a conventional automated testing tool causes a computer-controlled character to traverse a game environment automatically based upon testing instructions within the computer-executable code of the video game application. Such conventional automated video game testing tools are not scalable or portable to other games because they must be executed within the specific video game application for which they were designed.

By nature of their execution within the video game application, conventional automated testing tools may perform adequately with respect to detecting programming bugs or latency issues associated with the computing system executing the game; however, conventional tools fail to observe or capture bugs that are primarily observable during actual gameplay, for example, when a user interacts with a game by setting forth input into the game by way of a gamepad, controller, keyboard and mouse, etc. Moreover, conventional testing tools require specialized knowledge of the game being tested and dedicated computing resources to execute the game concurrently with the testing tool. Many game developers lack the required technical resources to design and implement effective automated testing tools for different games.

### SUMMARY

The following is a brief summary of subject matter that is described in greater detail herein. This summary is not intended to be limiting as to the scope of the claims.

Various technologies pertaining to an intelligent agent platform for video game testing are described herein. The intelligent agent platform facilitates design and deployment of intelligent agents that execute certain interactive tasks related to video game testing. For example, an intelligent agent interacts with a testing computing system executing a video game application to perform certain acts within the video game application. The intelligent agent interacts with the video game application by way of input into the game. For example, the intelligent agent controls movement and action of a character within a game by way of a virtual controller (e.g., an emulated console controller, gamepad, joystick, keyboard and mouse, etc.). The intelligent agent interacts with the video game application to execute one or more interactive tasks and captures testing data related to the interaction.

The testing data captured by the intelligent agent is indicative of observations during the interaction between the intelligent agent and the video game application. In an example, the testing data comprises a log of the display output of the video game application, controller buttons being activated, the position of a character on screen, objects being interacted with, etc. The testing data may optionally be enhanced, enriched, or otherwise modified by the intelligent agent platform and stored and/or transmitted to an external computing system (e.g., a client computing system operated by a game developer). In some examples, the intelligent agent platform deploys a plurality of intelligent agents to interact with separate instances of the video game application, wherein the plurality of intelligent agents can execute interactive tasks concurrently. Testing data from the plurality of intelligent agents may be aggregated before enhancement and/or storage and transmission.

It is a further aspect of the technologies described herein that the intelligent agent platform maintains a data store of intelligent agents that can be used to interact with and collect data from multiple different video game applications. In an example, an intelligent agent data store may store an intelligent agent that executes interactive tasks related to manipulating a character within a video game application to trace every location on a map. Intelligent agents that execute general tasks have utility in many different types of games. A task-specific intelligent agent may therefore be obtained from an intelligent agent data store and deployed by the intelligent agent platform. The intelligent agent platform adopts a unified architecture for intelligent agents which allows agents to be deployed in various different video game environments, regardless of the specific game or game engine.

In yet another aspect of the technologies described herein, the intelligent agent platform facilitates deployment of intelligent agents that are designed in whole or in part by a third party (e.g., a game developer). In an example, the intelligent agent platform receives an intelligent agent from a client computing system executing a client intelligent agent application. In some examples, the intelligent agent is designed using the client intelligent agent application. In another example, the client computing system (e.g., by way of the client intelligent agent application) receives input indicative of tasks to be executed by an intelligent agent. For example, the intelligent agent platform receives an intelligent agent request comprising tasks to be executed by an intelligent agent and then the intelligent agent platform modifies an existing intelligent agent (e.g., stored in the intelligent agent data store) and/or generates a new intelligent agent based upon the tasks indicated by intelligent agent request.

The above-described technologies present various advantages over conventional video game testing technologies. For example, the described intelligent agent platform facilitates the deployment of intelligent agents that are operable for use with a broad range of video games and video game environments. Conventionally, video game testing tools are game-specific (or game engine-specific) and cannot be used to test a wide range of games. Moreover, conventional testing tools executing within the game application fail to capture input sequences as they would occur during typical gameplay. By executing external to the video game application, the described intelligent agents can interact with the video game application by way of a virtual controller commands. External input interaction with the video game application yields more accurate and realistic gameplay testing data.

Yet another improvement over conventional video game testing applications is the ability for the described intelligent agent platform to facilitate design of intelligent agents (e.g., by game developers) using a consistent and reusable framework provided by the intelligent agent platform. The intelligent agent platform can host different intelligent agents in a data store such that intelligent agents may be selectively deployed for interaction with a wide variety of video game applications. In some examples, the intelligent agent platform facilitates the sharing of intelligent agents between users of the platform, enabling a more robust offering of intelligent agents that may be used in connection with video game testing across a much wider range of video game applications.

Certain functionality of the technologies described herein are illustrated through the following examples. In a first example, a computing system comprising a processor and a memory is described. The memory stores an intelligent agent application that, when executed by the processor, causes the processor to execute the intelligent agent application and execute certain functionalities associated with the intelligent agent application. Responsive to receiving an intelligent agent deployment request, the intelligent agent application deploys an intelligent agent to interact with a testing computing system. The testing computing system has a processor and a memory storing a video game application that is executed by the testing computing system. The testing computing system may be any computing system configured to execute a video game application, for example, a video game console, handheld video game device, a desktop computer, laptop computer, tablet computer, smart phone, or the like.

The intelligent agent deployment request outlines the parameters for an intelligent agent to be used for testing the video game application. In an example, the intelligent agent deployment request comprises one or more tasks to be executed by the intelligent agent related to the video game application. For example, the one or more tasks may be related to executing various aspects of the video game application (e.g., controlling a character, manipulating an object, interacting with a graphical environment, etc.) for testing and observation thereof. The intelligent agent application causes the intelligent agent to interact with the video game application and execute the one or more tasks associated with the intelligent agent deployment request. In some examples, the intelligent agent executes a secondary or follow up task based upon execution of a first task. For example, if the first task being executed by the intelligent agent requires traversal of every point on a map of the video game application, a follow up task could relate to actions to take responsive to interaction with certain points of interest (e.g., certain obstacles, non-playable characters, etc.). The intelligent agent can execute the follow up task (e.g., according to task logic of the intelligent agent) before returning to executing the first task.

The intelligent agent also captures testing data from the video game application and/or the testing computing system. The testing data is indicative of the interaction between the intelligent agent and the video game application. The testing data comprises all data that is output by the testing computer system while executing the video game application. In some examples, the testing data includes vision data, ray trace data, viewpoint capture, frame capture, audio data, controller buttons being activated, sensor data, etc.

The intelligent agent stores the testing data in a data store. In some examples, the testing data is stored locally at the testing computing system where it may be accessed by the intelligent agent application after testing is completed. The testing data may be later accessed by game developers or the like for purposes of fixing or mitigating bugs, analyzing performance of certain aspects of the computing system executing the video game application, etc. In some examples, the intelligent agent application can enhance, enrich, or otherwise modify the testing data. In one example, the enhanced testing data may be stored at a data store managed by the intelligent agent computing system and/or transmitted externally. In another example, the intelligent agent application captures testing data and provides the data as input into a bug detection model, wherein the bug detection model analyzes the input data and produces an output indicative of detected bugs or other anomalies.

While generally described with respect to testing video games, it is appreciated that the intelligent agent platform described herein has further advantageous application in other computing contexts, for example, using intelligent agents to conduct testing of other types of computer-executed applications. It is further appreciated that the described intelligent agent platform could also be used in any application where development and deployment of intelligent agents is used.

The above presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an example intelligent agent platform.

FIG. 2 is a functional block diagram of an example intelligent agent manager component of the intelligent agent platform.

FIG. 3 is a functional block illustrating an exemplary interaction between an intelligent agent and a testing computer system.

FIG. 4 is a flow diagram that illustrates an example methodology for executing an intelligent agent application.

FIG. 5 is a flow diagram that illustrates another example methodology for executing an intelligent agent application.

FIG. 6 depicts an example computing device.

Various technologies pertaining to an intelligent agent platform for video game testing are described herein and are now described with reference to the drawings, wherein like reference numerals are used to refer to like elements throughout.

In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

### DETAILED DESCRIPTION

Various technologies pertaining to an intelligent agent platform for video game testing are described herein. The described intelligent agent platform presents various advantages over conventional video game testing technologies. As noted above, conventional video game testing methodologies suffer from numerous limitations. For example, conventional automated testing tools are developed for an individual video game and are executed within an instance of the game. This prevents testing tools from being shared between games or requires substantial reprogramming of the testing tool to use with another game or game engine. Furthermore, because conventional tools are executed within an instance of the video game application, they fail to capture useful contextual testing data related to the actual inputs as they would be received during user-executed gameplay. The output of conventional testing data may further require complex and computationally expensive extrapolation techniques (e.g., machine vision) to extract certain information from the testing data generated by way of internal game testing tools.

As will be described in greater detail with reference to the drawings, the intelligent agent platform improves over conventional video game testing technologies by 1) providing intelligent agents that can be used (and reused) across different games and game engines; 2) providing a unified platform for designing, generating, and sharing intelligent agents; and 3) generating more accurate and useful testing data by way of external interaction with a video game application that more effectively captures realistic gameplay testing data.

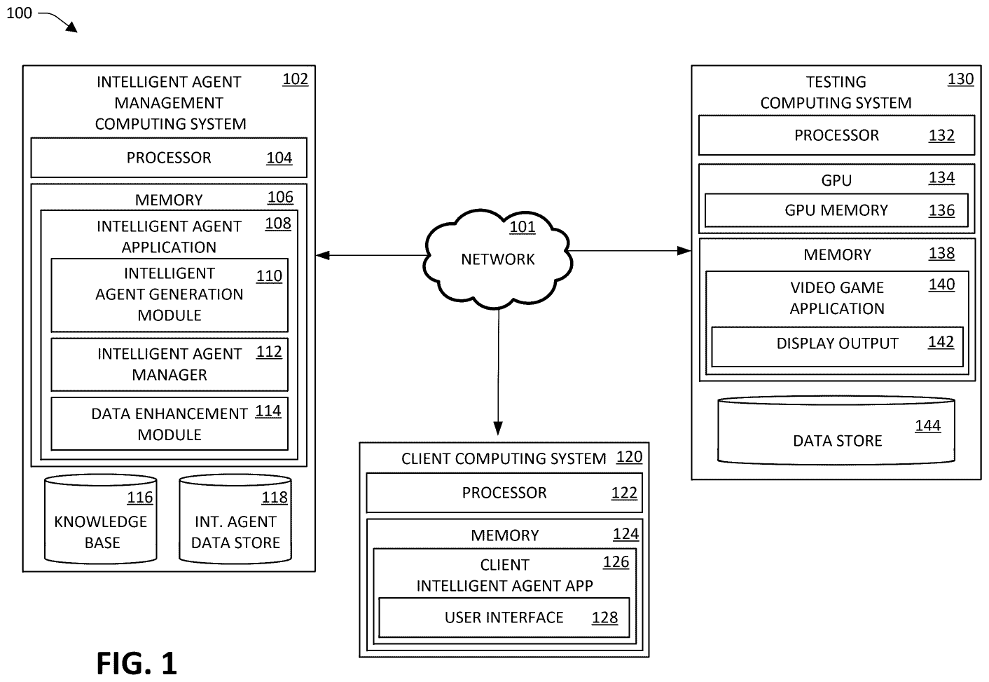

With reference to FIG. 1, an example intelligent agent platform 100 is illustrated. The intelligent agent platform 100 comprises an intelligent agent management computing system 102, client computing system 120, and testing computing system 130. The intelligent agent management computing system 102, client computing system 120, and testing computing system 130 are operably connected by way of network 101 (e.g., the Internet, intranet, or the like). The intelligent agent platform 100 facilitates the generation and use of intelligent agents (e.g., by way of intelligent agent management computing system 102 and/or client computing system 120) for use with testing computing system 130.

The intelligent agent management computing system 102 is responsible for generation and management of intelligent agent assets and data obtained therefrom. According to some examples, the intelligent agent management computing system 102 is a server computing device. According to other examples, the intelligent agent management computing system 102 is a cloud-based computing platform. While intelligent agent management computing system 102 is depicted as a single computing system, it is appreciated that agent management computing system 102 and its components may be a distributed computing system comprising a plurality of computing systems operably connected over a network (e.g., Internet, intranet, etc.) and configured to collectively perform the functionality of intelligent agent management computing system 102.

The intelligent agent management computing system 102 includes a processor 104 and memory 106. Processor 104 may include one or more processor cores to process computer-executable instructions (e.g., stored in memory 106), such that, when executed, cause the processor to perform certain functionality as described with reference to agent management computing system 102 and/or its component parts. Memory 106 can be a dynamic random access memory (DRAM) device, a static random access memory (SRAM) device, flash memory device, phase-change memory device, or some other memory device suitable to serve as process memory. Intelligent agent management computing system 102 further comprises knowledge base 116 and intelligent agent data store 118.

Memory 106 stores computer-executable instructions comprising at least an intelligent agent application 108. The intelligent agent application 108 facilitates the generation and management of intelligent agents. Intelligent agent application 108 also facilitates data enhancement of testing data captured by and/or in connection with operation of intelligent agents managed by intelligent agent management computing system 102. The intelligent agent application 108 comprises intelligent agent generation module 110, intelligent agent manager 112, and data enhancement module 114. The intelligent agent application 108 may be communicatively coupled (e.g., over network 101) with client intelligent agent application 126 executing on client computing system 120.

As will be described in greater detail below, the intelligent agent management computing device 102, by way of intelligent agent application 108, is generally configured to (1) receive an intelligent agent deployment request comprising one or more tasks to be executed by an intelligent agent (e.g., in connection with testing a video game application); (2) responsive to receiving the intelligent agent deployment request, deploy an intelligent agent to interact with a testing computing system executing a video game application; (3) cause the intelligent agent to interact with the video game application and execute a first task of the one or more tasks; (4) obtain testing data from the intelligent agent, wherein the testing data is indicative of execution of one or more tasks; (5) enhance the testing data; and (6) store the enhanced testing data.

The intelligent agent application 108 generates new intelligent agents by way of intelligent agent generation module 110. The intelligent agent generation module 110 facilitates the generation of intelligent agents for use by the intelligent agent platform 100. In some examples, the intelligent agent application 108 obtains existing intelligent agents from the intelligent agent data store 118. In an example, intelligent agent generation module 110 generates an intelligent agent to execute certain tasks related to video game testing. The intelligent agent generation module 110 generates intelligent agents according to a common framework shared by all intelligent agents used in connection with the intelligent agent platform 100. This enables each intelligent agent to be used across different testing environments regardless of the game or game engine.

In some examples, intelligent agent generation module 110 generates an intelligent agent according to an intelligent agent deployment request. The intelligent agent deployment request may contain parameters (e.g., in a configuration file) which direct behavior of an intelligent agent and/or indicate certain tasks that an intelligent agent is to execute. In an example, an intelligent agent generated by the intelligent agent generation module 110 comprises one or more models that enable the intelligent agent to take autonomous actions based upon an interaction. The models may be trained upon data stored at knowledge base 116.

In general, an intelligent agent deployed by the intelligent agent application 108 takes in data and determines the next action to take based upon the tasks it has been deployed to execute. It is appreciated that intelligent agent, as used herein, encompasses any computer-executed agent operable to perceive an environment, take autonomous action to achieve goals, and improve performance through continued action or acquired data or knowledge. For example, an intelligent agent may be a reflex agent which acts on the basis of a current percept (ignoring prior percepts), a model-based reflex agent which maintains an internal model that which accounts for historical percepts to impact action, a goal-based agent which uses a model to account for historical percepts to impact action towards one or more specific goals, a utility-based agent which determines variable performance of goals and utility of outcome, a learning agent which uses performance feedback to modify future action, or the like.

In an example, the intelligent agent executes a first task and then executes a secondary or follow up task based upon execution of the first task and/or testing data (or enhanced testing data) received responsive to execution of the first task. In an example, the intelligent agent executes a secondary task based upon an indication of success or failure of the first task. If a first task is to jump up to a platform and the intelligent agent receives an indication that the jump was unsuccessful (e.g., character is in the same spot, character fell down a hole, etc.) the second task may relate to finding an alternative path or angle for a different jump action. As another example, the intelligent agent may execute a secondary task based upon indication of a bug (e.g., by way of enhanced testing data) related to execution of the first task. As yet another example, the intelligent agent may execute a secondary task based upon warnings or logs detected within the testing data related to execution of the first task. As another example, if the first task being executed by the intelligent agent requires traversal of every point on a map of the video game application, a follow up task could relate to actions to take responsive to interaction with certain points of interest (e.g., certain obstacles, non-playable characters, etc.). The intelligent agent can execute the follow up task (e.g., according to a model of the intelligent agent) before returning to executing the first task. Intelligent agents generated by intelligent agent generation module 110 may be stored in intelligent agent data store 118.

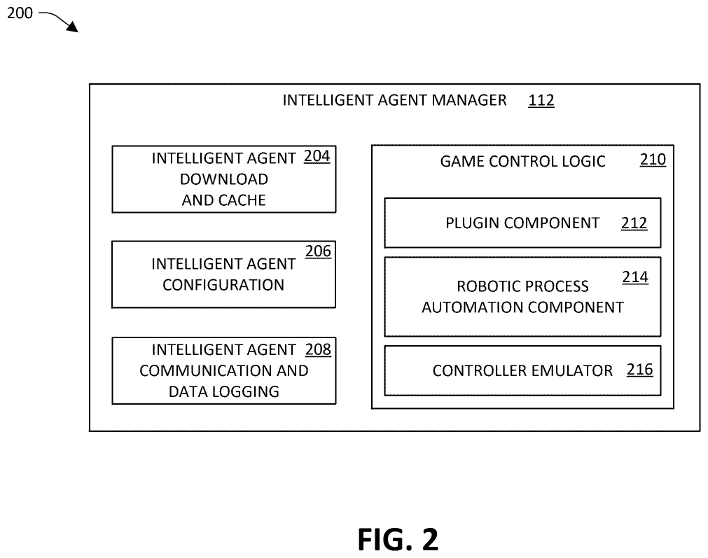

Intelligent agent manager 112 manages the deployment of intelligent agents (e.g., for video game testing). The intelligent agent manager 112 is responsible for obtaining an intelligent agent, configuring the intelligent agent, deploying the intelligent agent, and/or managing data obtained by the intelligent agent. In an example, intelligent agent manager 112 obtains an intelligent agent from intelligent agent data store 118 and causes the intelligent agent to be deployed to execute one or more testing tasks at testing computing system 130. Additional aspects of intelligent agent manager 112 are described in greater detail with reference to FIG. 2.

With reference to FIG. 2, functional block diagram 200 illustrates a detailed view of intelligent agent manager 112. Intelligent agent manager 112 comprises several component parts that enable management of intelligent agents within the intelligent agent platform 100. For example, intelligent agent manager 112 comprises an agent download and cache component 204. The agent download and cache component 204 obtains an intelligent agent (e.g., from intelligent agent data store 118). The agent download and cache component 204 is used by the intelligent agent manager 112 to prepare intelligent agents for deployment. In an example, the agent download and cache component 204 deploys an intelligent agent within a container.

In some examples, the intelligent agent manager may deploy multiple intelligent agents to operate in parallel. For example, a first intelligent agent may be deployed to a first testing computing system to execute a first task. A second intelligent agent may be deployed to a second computing system to execute a second task and so forth. In this example, each computing system may be executing a separate instance of the same video game application and the first and second task are discrete tasks. This enables scalable testing to be executed using the intelligent agent platform 100. In some examples, the first and second agents are different agents with different configurations. Again, this enables scalable testing to occur in parallel across several testing computing systems. In another example, the first and second intelligent agent and the first and second testing computing systems are identical in configuration. This enables intelligent agent manager 112 to obtain testing data from each of the first testing computing system and the second computing system and compare the resulting testing data (e.g., by way of data enhancement module 114) to determine if anomalies exist. In one further example, a plurality of testing computing systems are connected by way of a network to execute a multiplayer video game. A plurality of intelligent agents could be deployed, with each agent interacting with a respective testing computing system while executing the multiplayer game. The resulting testing data could then be aggregated for analysis of performance of the multiplayer game from each of the different perspectives of the plurality of intelligent agents.

The intelligent agent manager 112 further comprises an intelligent agent configuration component 206. The agent configuration component 206 may apply certain configuration settings to an intelligent agent obtained by the agent download and cache component 204. For example, a general character movement intelligent agent may be obtained (e.g., from intelligent agent data store 118) by the agent download and cache component 204 and the intelligent agent configuration component 206 may modify the existing intelligent agent, for example, to add game-specific instructions or logic to the intelligent agent. In an example, the intelligent agent configuration component 206 configures an intelligent agent with an offline model of a game, which is indicative of starting points for certain objects, barriers, character experience, difficulty settings, or the like. In another example, intelligent agent configuration component 206 configures an intelligent agent with a development specific state, which may dictate certain actions taken by the intelligent agent in a development context (e.g., as opposed to testing an in-production version of the video game application). In another example, intelligent agent configuration component 206 configures an intelligent agent with a prior model state, which may load parameters of a game in a specific moment in time (e.g., the point in time that a prior intelligent agent ceased interaction with the video game application, the point in time a game crashed, etc.).

The intelligent agent manager 112 further comprises an intelligent agent communication and data logging component 208. The intelligent agent communication and data logging component 208 is responsible for receiving testing data obtained from the intelligent agent during interaction with the testing computing system 130. In some examples, the intelligent agent communication and data logging component 208 provides the testing data to the data enhancement module 114. In some examples, the testing data includes vision data, ray trace data, viewpoint capture, frame capture, audio data, controller buttons being activated, etc. In some examples, the types of data captured by the intelligent agent communication and data logging component 208 is specified as part of a configuration file received by the intelligent agent configuration module 206. In some examples, a configuration file may be generated by the intelligent agent application 108 based upon an intelligent agent deployment request.

As described above, intelligent agent manager 112 is responsible for obtaining and configuring an intelligent agent as well as deploying the intelligent agent. Once the intelligent agent is deployed and operable to interact with the testing computing system 130, the intelligent agent executes certain tasks according to game control logic 210. The intelligent agent may execute certain acts autonomously or responsive to receiving commands from the intelligent agent manager 112. In some examples, the agent manger 112 sends commands to the intelligent agent by way of the game control logic 210.

Game control logic 210 comprises a plugin component 212, a robotic process automation component 214, and a controller emulator 216. The plugin component 212 enables game control logic 210 to integrate existing plugin functionality into an intelligent agent. Certain video game environments may utilize an existing plugin for game control. Plugin component 212 may add movement functionality to the intelligent agent based upon the known plugin (e.g., as opposed to emulating controller input). In an example, when the intelligent agent uses a movement plugin, the intelligent agent sends actions and their values to the game engine and the game engine will emulate the movement within the plugin. Game control logic 210 further comprises robotic process automation (RPA) component 214. Where a plugin may not be available, the RPA component 214 may add RPA-based movement logic to the intelligent agent. For example, RPA may be used to emulate pointing and clicking using a mouse input device.

Game control logic 210 further comprises a controller emulator 216. Controller emulator 216 is configured to emulate available input into a video game application (e.g., video game application 140). For example, pressing buttons on a gamepad controller, moving a joystick, accelerometer movement, touch input, turning a steering wheel, voice commands, typing on a keyboard, and moving and clicking a mouse, etc. In some examples, controller emulator 216 simulates input by way of augmented reality (AR) and/or virtual reality (VR) devices. AR and VR devices may determine user input by way of detected movement or other sensor data. For example, one or more sensors (e.g., gyroscopic, magnetometer, 6-degree-of-freedom, etc.) associated with an AR or VR device may movement data which is used as input into a video game. In some examples, the input methodology used by the intelligent agent to interface with the video game application 140 may be restricted to a subset of available input methods. In one example, the intelligent agent manager 112 may configure an intelligent agent to only use controller emulator 216 to provide testing data limited specifically to that input type. More specifically, intelligent agent manger 112 may configure an intelligent agent to use only a subset of available input types (e.g., just a steering wheel, only directional pad, etc.).

In some examples, the game control logic defines an action space which dictates game control by the intelligent agent. The action space may define each potential action (e.g., pressing spacebar causes a jump, moving a directional pad left causes a character to move left, etc.). Each action in the action space may have bounds (e.g., high or low) which characterize degrees of the action. In some examples, game control logic 210 comprises certain input sequences. For example, certain input patterns may be commonly used for to test certain features or perform certain task. In an example, game control logic 210 comprises an input sequence which, when executed by the intelligent agent executes the input sequence up, up, down, down, left, right, left, right, B, A, START. As the intelligent agent interacts with the testing computing system, testing data is captured by the intelligent agent.

Returning now to FIG. 1, intelligent agent application 108 further comprises data enhancement module 114. As data is captured by the intelligent agent, it may be stored locally and/or transmitted back to the agent management computing system 102 for use by data enhancement module 114. Data enhancement module 114 enriches, enhances, or otherwise modifies data obtained by the intelligent agent application 108 (e.g., data captured by an intelligent agent during an interaction with a video game application). The raw data obtained from the intelligent agent application 108 may not be in a format that is usable for certain analysis.

In some examples, data enhancement module 114 enhances data by way of one or more computer-executed data enhancement models. For example, the data enhancement module 114 may provide testing data as input into a data enhancement model wherein the data enhancement model outputs enhanced data based upon the input. In one example, a data enhancement model is an object detection model configured to detect and classify objects within the testing data. For example, for a rendered frame of testing data, an object detection model may detect and distinguish game characters, map elements, interactive elements, non-interactive elements, etc. In another example, the data enhancement model is a generative model. A generative model receives an input and in near real-time (e.g., within a few seconds of receiving the input) generates an output that is responsive to the input. The output generated by the model is often human readable text, but generative models can also produce output in the form of executable source code, images, music, video, etc. In some examples, the generative model is a transformer-based large language model (LLM) (e.g., Bidirectional Encoder Representations from Transformers (BERT), Generative Pre-trained Transformer (GPT), Large Language Model Meta AI (LLaMa), etc.). In yet another example, the data enhancement model is a bug detector model. A bug detector model receives input (e.g., testing data) and generates an output indicative of bugs or other anomalies within the testing data. In an example, a bug detector model receives a frame of rendered video from video game application 140 and generates an output indicative one or more bugs related to visual level of detail (LoD) discontinuities, missing textures, wrong textures, etc. Different bug detector models can be developed and trained to detect specific bugs from the testing data. In some examples, the data enhancement models are trained upon data stored in knowledge base 116.

In an example, the intelligent agent captures raw testing data comprising pixel data. Data enhancement module 114 enhances the raw pixel data by way of an image recognition model which adds text metadata to the pixel data. The text metadata may be further enhanced by way of a generative model or the like. For example, the data enhancement module 114 can provide textual metadata extracted from the enhanced pixel data as input into a data enhancement model. The generative model then produces an output which enhancement module 114 stores and/or further enhances (e.g., by providing the output as input into another data enhancement model). Data enhancement module 114 may comprise additional data enhancement models, such as for example, optical character recognition (OCR), telemetry models, ray trace models, bug detection models, etc.

In some examples, data enhancement module 114 comprises a ray trace object detection model. In one example, data enhancement module 114 (by way of a ray trace object detection model) extracts ray trace data from the testing data and aligns the ray trace data with a rendered screen frame to perform object detection. This technique provides enhanced object detection as opposed to conventional machine vision techniques which relied upon assumptions as to the visibility of an object, visual checks for object location, and/or machine vision to detect objects. In another example, data enhancement module 114 (by way of an object detection model) extracts object metadata from the testing data. For example, data enhancement module 114 may provide testing data as input into an object detection model which detects an object, and for the detected object, extracts metadata associated with the object, for example, a unique object identifier, an object type identifier, an expected texture identifier, tags assigned to the object during development or instantiation of the object, etc.

In some examples, data enhancement module 114 may enhance data using multiple models, for example, providing output from one model as input into another. The data enhancement module 114 may also include additional testing data along with model output in the input into another model. In an example, the data enhancement module 114 provides testing data as input into an object detection model and obtains output from the model indicative of detected objects and their associated metadata. The data enhancement module 114 then provides the output of the object detection model as input into a bug detection model. The bug detection model then generates an output indicative of one or more bugs relating to the detected objects. In an example, a bug detection model can detect bugs related to visual level of detail (LoD) discontinuities, missing textures, wrong textures, etc., based upon the output of the object detection model and testing data (e.g., point of view/camera position corresponding to the video frame buffer being output). The object metadata (e.g., object ID, object type, texture ID, feature tags, etc.), the output of the bug detection model, and/or additional testing data is then provided by the data enhancement module 114 as input into a generative model, wherein the generative model generates a report representative of identified objects, their bugs, and potential fixes.

Intelligent agent platform 100 further comprises client computing system 120. The client computing system 120 comprises a processor 122 and memory 124. Memory 124 stores instructions comprising at least a client intelligent agent application 126. Client intelligent agent application 126 further comprises user interface 128. Intelligent agent application 108 and client intelligent agent application 126 are communicatively coupled (e.g., by way of network 101). Client intelligent agent application 126 enables design of an intelligent agent for video game testing. In some examples, the client intelligent agent application 126, by way of user interface 128, generates an intelligent agent deployment request. The intelligent agent deployment request may contain parameters (e.g., in a configuration file) which direct behavior of an intelligent agent and/or certain tasks that an intelligent agent is to execute. The intelligent agent application 108 (e.g., by way of intelligent agent generation module 110) may then obtain an existing intelligent agent and/or generate a new intelligent agent responsive to receiving the intelligent agent deployment request.

In some examples, the client intelligent agent application 126 receives input in the form of computer-executable code or a computer-executable model that can be included in an intelligent agent (e.g., as generated and/or modified by intelligent agent application 108). In yet another example, the client intelligent agent application 126 may browse existing intelligent agents within the intelligent agent data store 118. Upon selecting an existing intelligent agent, the client intelligent agent application 126 may customize aspects of the intelligent agent (e.g., to optimize the intelligent agent for a specific task). In another example, the client intelligent agent application 126 receives input in the form of computer-executable code or a computer-executable model that can be used by data enhancement module 114 enhance testing data. In one example, the client intelligent agent application 126 receives as input a computer-executable bug detection model. The bug detection model may then be provided to the intelligent agent application 108 for use with data enhancement module 114 in order to perform bug detection on the testing data.

Intelligent agent platform 100 further comprises testing computing system 130. The testing computing system 130 may be any computing system configured to execute a video game application for purposes of testing the video game application, for example, a video game console, handheld game device, desktop computer, laptop computer, tablet computer, smart phone, or the like. While shown as an application executing in memory, it is appreciated that in some examples, the video game application is executed by way of a computer-readable media.

The testing computing system 130 comprises a processor 132 and graphical processing unit (GPU) 134. The GPU 134 has a dedicated GPU memory 136. Memory 138 stores computer-executable instructions comprising at least a video game application 140. The testing computing system 130 executes video game application 140 which, in some examples, is controlled using an intelligent agent. During execution of the video game application 140, testing data is obtained from the testing computing system 140. In some examples, the testing data includes vision data, ray trace data, viewpoint capture, frame capture, audio data, controller buttons being activated, sensor data, etc., related to execution of the video game application 140. Certain visual data is captured by way of display output 142, which outputs visual and/or audio data. In some examples, the testing data comprises data indicative of performance metrics of the testing computing system (e.g., processor 132, GPU 134, memory 138, GPU memory 136, etc.). In some examples, testing data and/or other data relating to execution of video game application 140 is stored in data store 144.

In exemplary operation, the computing system 102 receives an intelligent agent deployment request comprising one or more tasks to be executed by an intelligent agent (e.g., in connection with testing a video game application). The intelligent agent deployment request may comprise parameters (e.g., in a configuration file) which direct behavior of an intelligent agent and/or certain tasks that an intelligent agent is to execute. In some examples, the intelligent agent deployment request defines a starting state that the intelligent agent begins interaction with the video game application 140 (e.g., a development state, a previous state of a prior intelligent agent, after the game application crashes and/or experiences an error, etc.). The intelligent agent deployment request may be generated by way of client intelligent agent application 126 and transmitted to the intelligent agent application 108.

Responsive to receiving the intelligent agent deployment request, the intelligent agent application 108 determines if an existing intelligent agent (e.g., in intelligent agent data store 118) is operable to execute tasks outlined in the intelligent agent deployment request. In one example, a suitable intelligent agent is identified in intelligent agent data store 118 and deployed by intelligent agent manager 112. In another example, a suitable intelligent agent is identified and modified by the intelligent agent manager 112 (e.g., by way of intelligent agent configuration component 206). In yet another example, no suitable intelligent agent is identified and the intelligent agent application 108 generates (by way of intelligent agent generation module 110) a new intelligent agent according to the intelligent agent deployment request. In yet another example, the intelligent agent deployment request comprises computer-executable code that can be integrated into an intelligent agent. In another example, the intelligent agent deployment request comprises a complete functional intelligent agent, that may be deployed using intelligent agent manager 112.

Upon identifying and/or generating an intelligent agent operable to execute the tasks indicated in the intelligent agent deployment request, the intelligent agent application (e.g., by way of intelligent agent manager 112) deploys the intelligent agent to interact with a testing computing system executing a video game application (e.g., video game application 140). In some examples, the intelligent agent is deployed within a container.

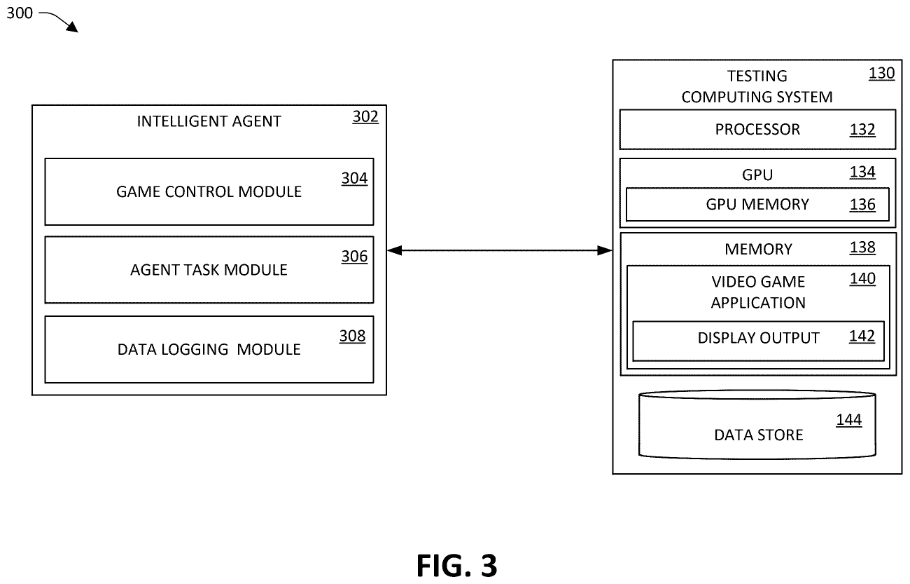

The intelligent agent application 108 then causes the intelligent agent to interact with the video game application 140 and execute a first task of the one or more tasks indicated in the intelligent agent deployment request. In an example, the intelligent agent is caused to interact with the video game application 140 by nature of being deployed by intelligent agent application 108. An exemplary interaction between an intelligent agent and the testing computing system 130 is described with reference to FIG. 3.

FIG. 3 illustrates functional block diagram 300 which illustrates an exemplary interaction between intelligent agent 302 and testing computer system 130. In an example, the intelligent agent 302 and testing computer system 130 are operably connected by way of a network (e.g., network 101). In another example, the intelligent agent 302 is executed locally by testing computing system 130. Intelligent agent 302 comprises a game control module 304, an agent task module 306, and a data logging module 308. The game control module 304 comprises logic which enables the intelligent agent to control aspects related to video game application 140. In an example, game control module 304 comprises game control logic 210, and is further operable to control video game application 140 by way of a plugin, RPA, or an emulated controller.

Actions performable by the intelligent agent 302 may be defined according to an action space as part of game control module 304. The action space defines each potential action within a video game application (e.g., pressing spacebar causes a jump, moving a directional pad left causes a character to move left, etc.). Each action in the action space may have bounds (e.g., high or low) which characterize degrees of the action. In an example, there are two types of actions in the action space, player inputs and debug commands. Player inputs comprise any control inputs (e.g., by way of key press, button push, mouse click, joystick toggle, touch, accelerometer, etc.) that occur within playing of the video game application 140. Debug commands are control inputs that invoke special debug functionality with the video game application 140 (e.g., load a specific level, kill all nearby enemies, etc.). In an example, intelligent agent 302 is configured to execute all actions in the action space before testing is completed.

The interaction between intelligent agent 302 and testing computing system 130 is controlled according to intelligent agent task module 306. In general, the intelligent agent task module 306 comprises computer-executable logic that enables the intelligent agent 302 to take in data (e.g., testing data) and determine the next action to take based upon one or more tasks within the task module 306. The intelligent agent task module 306 may comprise one or more tasks from an intelligent agent deployment request. In an example, the intelligent agent configuration component 206 configures the intelligent agent task module 306 to execute one or more tasks from an intelligent agent deployment request.

In some examples, the agent task module 306 comprises one or more intelligent agent task models that are trained upon data relating to video game testing, such that when the agent task module 306 receives testing data resulting from the interaction between the intelligent agent 302 and the testing computing system 130, the agent task module 306 causes the intelligent agent 302 to execute a task based upon the output of one or more of the models. In one example, the agent task module 306 comprises hard-coded task instructions. In another example, the agent task module 306 comprises a neural network (e.g., artificial neural network (ANN), a Bayesian model, a deep neural network (DNN), a recurrent neural network (RNN), a convolutional neural network (CNN) model) with a wrapper.

In an example, the intelligent agent 302 performs a first task based upon a task indicated in an intelligent agent deployment request. The intelligent agent 302 executes the first task. Testing data indicative of the execution of the first task is provided as input into a machine learning model within agent task module 306. The agent task module 306 then causes the intelligent agent 302 to execute a second task, based upon the output of the machine learning model.

Responsive to the agent task module 306 executing tasks within the video game application 140, testing data is generated (e.g., by the testing computing system 130). The testing data is captured by the data logging module 308 of intelligent agent 302 for each rendered frame of the video game application 140. In an example, testing data comprises a screenshot with a timestamp, audio being played, objects being displayed, buttons being pressed, and/or other game data at the time the frame is rendered.

In one example, the testing data is stored locally (e.g. in data store 144) and obtained by the intelligent agent 302 after testing is complete. In an example, the testing data captured by the data logging module 308 is logged through a SDK which defines the data in a way that one or more data enhancements (e.g., by way of data enhancement module 114) can use the data more effectively. In an example, the data logging module 308 logs testing data in a format for use with a bug detector. The bug detector may then receive the logged testing data as input and generate an output indicative of bugs or other anomalies within the testing data. In another example, data logging module 308 is configured to capture testing data and transmit the testing data to a bug analysis pipeline in real-time or near real-time. In some examples, the intelligent agent 302 modifies the frame rate of the video game application depending on a desired accuracy of testing data. For example, certain tasks (e.g., targeting a far away enemy that is moving) may require more frames per second to properly contextualize certain bugs or anomalies. Because testing data is created for each rendered frame, more frames per second increases the details captured by the testing data.

Once the intelligent agent 302 has completed all tasks assigned by the agent task module 306, testing data may be transmitted back to the intelligent agent generation module 110 to be stored and/or enhanced (e.g., by way of data enhancement module 114). As described herein, it is appreciated that while described with reference to single intelligent agent 302, the intelligent agent application 108 is operable to deploy a plurality of intelligent agents to execute testing tasks in parallel.

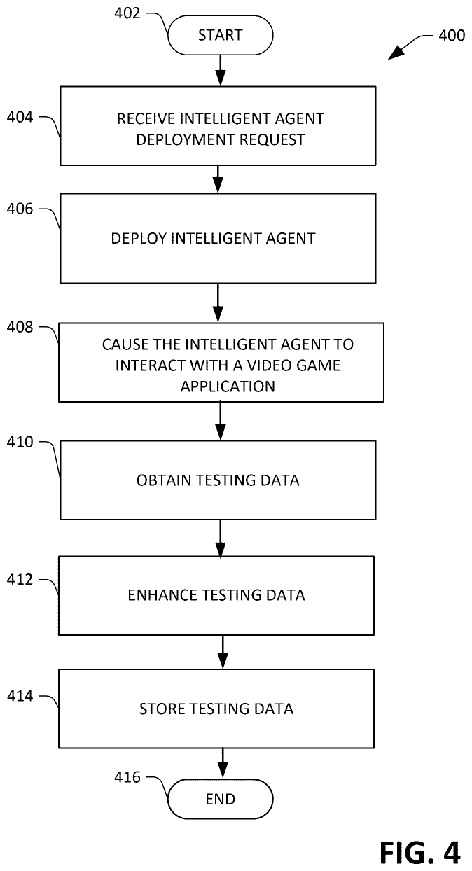

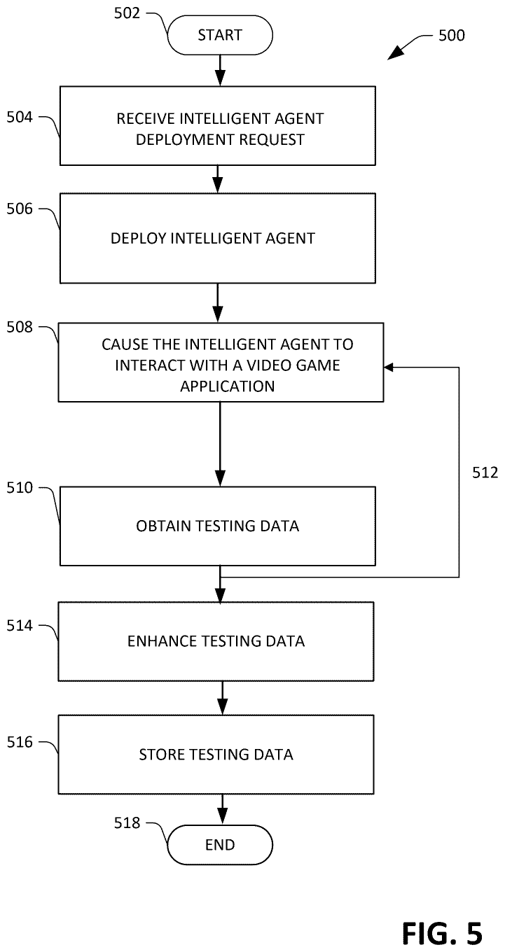

FIGS. 4 and 5 illustrate example methodologies relating to an exemplary intelligent agent application deploying one or more intelligent agents for video game testing. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement the methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring now to FIG. 4, an example methodology 400 related to use of intelligent agents for video game testing is illustrated. The methodology starts at step 402. At step 404, an intelligent agent deployment request is received. The intelligent agent deployment request comprises one or more tasks to be executed by an intelligent agent (e.g., in connection with testing a video game application). The intelligent agent deployment request may comprise parameters (e.g., in a configuration file) which direct behavior of an intelligent agent and/or certain tasks that an intelligent agent is to execute.

At step 406, an intelligent agent is deployed, for example, responsive to receiving the intelligent agent deployment request. In an example, the intelligent agent application identifies and existing agent operable to execute the tasks in the intelligent agent deployment request, generates a new intelligent agent, or modifies an existing intelligent agent to execute the tasks in the intelligent agent deployment request. In one example, the intelligent agent application receives an intelligent agent to deploy (e.g., from a client intelligent agent application).

At step 408, the intelligent agent is caused to interact with a video game application. In an example the intelligent agent is automatically caused to interact with the video game application by way of its configuration. In another example, the intelligent agent is caused to interact with the video game application in order to execute at least a first task indicated by the deployment request.

At step 410, testing data is obtained, wherein the testing data is indicative of the execution of the first task. In some examples, testing data is captured by the intelligent agent throughout the duration of the interaction with the video game application.

At step 412, the testing data is enhanced (e.g., by data enhancement module 114). In an example, the testing data is enriched, enhanced, or otherwise modified. In an example, enhancing the testing data comprises providing the testing data as input into a bug detector model, wherein the bug detector model produces an output indicative of bugs or other anomalies within the data.

At step 414, the testing data (enhanced or otherwise) is stored. The methodology 400 ends at 416.

Referring now to FIG. 5, an example methodology 500 related to use of intelligent agents for video game testing is illustrated. The methodology starts at step 502.

At step 504, an intelligent agent deployment request is received. The intelligent agent deployment request comprises one or more tasks to be executed by an intelligent agent (e.g., in connection with testing a video game application). The intelligent agent deployment request may comprise parameters (e.g., in a configuration file) which direct behavior of an intelligent agent and/or certain tasks that an intelligent agent is to execute.

At step 506, an intelligent agent is deployed, for example, responsive to receiving the intelligent agent deployment request. In an example, the intelligent agent application identifies and existing agent operable to execute the tasks in the intelligent agent deployment request, generates a new intelligent agent, or modifies an existing intelligent agent to execute the tasks in the intelligent agent deployment request. In one example, the intelligent agent application receives an intelligent agent to deploy (e.g., from a client intelligent agent application).

At step 508, the intelligent agent is caused to interact with a video game application to execute a first task indicated by the intelligent agent deployment request. In an example the intelligent agent is automatically caused to interact with the video game application by way of its configuration.

At step 510, testing data is obtained, wherein the testing data is indicative of the execution of the first task. In some examples, testing data is captured by the intelligent agent throughout the duration of the interaction with the video game application.

At step 512, the intelligent agent is caused to interact with the video game application to execute a secondary or follow up task based upon execution of a first task. For example, the intelligent agent executes the secondary task based upon testing data received responsive to execution of the first task.

At step 514, the testing data is enhanced (e.g., by data enhancement module 114). In an example, the testing data is enriched, enhanced, or otherwise modified. In an example, enhancing the testing data comprises providing the testing data as input into a bug detector model, wherein the bug detector model produces an output indicative of bugs or other anomalies within the data.

At step 516, the testing data (enhanced or otherwise) is stored. The methodology 500 ends at 518.

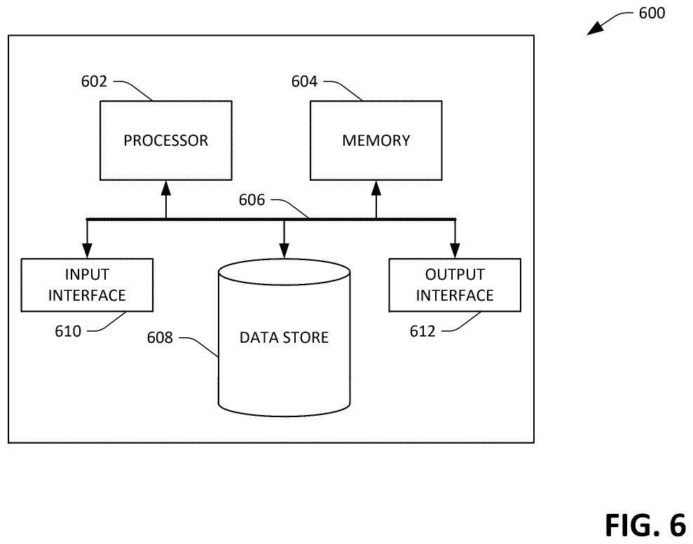

Referring now to FIG. 6, a high-level illustration of an example computing device 600 that can be used in accordance with the systems and methodologies disclosed herein is illustrated (e.g., computing system 102, client computing system 120, testing computing system 130, etc.). The computing device 600 includes at least one processor 602 that executes instructions that are stored in a memory 604. The instructions may be, for instance, instructions for implementing functionality described as being carried out by one or more components discussed above or instructions for implementing one or more of the methods described above. The processor 602 may access the memory 604 by way of a system bus 606.

The computing device 600 additionally includes a data store 608 that is accessible by the processor 602 by way of the system bus 606. The data store 608 may include executable instructions, computer-readable text that includes words, etc. The computing device 600 also includes an input interface 610 that allows external devices to communicate with the computing device 600. For instance, the input interface 610 may be used to receive instructions from an external computer device, from a user, etc. The computing device 600 also includes an output interface 612 that interfaces the computing device 600 with one or more external devices. For example, the computing device 600 may display text, images, etc. by way of the output interface 612.

It is contemplated that the external devices that communicate with the computing device 600 by way of the input interface 610 and the output interface 612 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 600 in a manner free from constraints imposed by input devices such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 600 may be a distributed system. Thus, for instance, several devices may be in communication by way of a network connection and may collectively perform tasks described as being performed by the computing device 600.

The present disclosure relates to an intelligent agent platform which deploys one or more intelligent agents for video game testing according to at least the following examples:
(A1) In one aspect, some embodiments include a method (e.g., 400, 500) executed by a processor (e.g., processor 104) of a computing system (e.g., computing system 102). The method comprises receiving an intelligent agent deployment request, wherein the intelligent agent deployment request comprises one or more tasks to be executed by an intelligent agent. The method further comprises deploying an intelligent agent to interact with a testing computing system, wherein the testing computing system is executing a video game application. The method additionally comprises causing the intelligent agent to interact with the video game application and execute a first task of the one or more tasks. The method further comprises obtaining testing data from the intelligent agent, wherein the testing data is indicative of the execution of the first task. The method additionally comprises storing the testing data at a data store.
(A2) According to some embodiments of the method of A1, the method further comprises enhancing the testing data by providing the testing data as input into at least one model, wherein, responsive to receiving the testing data as input, the at least one model produces and output comprising enhanced testing data.
(A3) According to some embodiments of any of the method of (A2), the at least one model is at least one of: a generative model, a bug detector model, or an object detection model.
(A4) According to some embodiments of any of the methods of (A1)-(A3), further comprising providing the enhanced testing data as input into a bug detector model, wherein the bug detector model generates an output indicative of at least one of a visual level of detail discontinuity, a missing texture, or an incorrectly applied texture.
(A5) According to some embodiments of any of the methods of (A1)-(A4), the method further comprises, prior to deploying the intelligent agent, obtaining the intelligent agent from an intelligent agent data store based upon the intelligent agent deployment request.
(A6) According to some embodiments of the method of (A5), the method further comprises subsequent to obtaining the intelligent agent from the intelligent agent data store, modifying the intelligent agent based upon input from a client computing device.
(A7) According to some embodiments of any of the methods of (A1)-(A6), the intelligent agent executes a second task based upon the execution of the first task.
(A8) According to some embodiments of any of the methods of (A1)-(A7), the intelligent agent executes a second task based upon the testing data.
(A9) According to some embodiments of any of the methods of (A1)-(A8), the intelligent agent interacts with the video game application by way of input into the video game application by way of an emulated controller executed by the intelligent agent.
(A10) According to some embodiments of any of the methods of (A1)-(A9), the method further comprises providing the testing data as input into a first model, wherein responsive to receiving the testing data as input, the first model generates an output comprising first enhanced testing data. The method further comprises providing the enhanced testing data as input into a second model, wherein responsive to receiving the enhanced testing data as input, the first model generates an output comprising second enhanced testing data.
(A11) According to some embodiments of any of the methods of (A1)-(A10), wherein the intelligent agent interacts with the video game application by way of providing input to the video game application, the provided input comprising input selected from the group consisting of input from an emulated controller, input from an emulated sensor, input from an emulated keyboard, and input from an emulated mouse.
(B1) In another aspect, some embodiments include a computing system (e.g., computing system 102) that includes a processor (e.g., processor 104) and memory (e.g., memory 106). The memory stores instructions that, when executed by the processor, cause the processor to perform any of the methods described herein (e.g., any of A1-A11).
(C1) In yet another aspect, some embodiments include a non-transitory computer-readable storage medium that includes instructions that, when executed by a processor (e.g., processor 104 of computing system 102), cause the processor to perform any of the methods described herein (e.g., any of A1-A11).

Various functions described herein can be implemented in hardware, firmware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. Such computer-readable storage media can include random-access memory (RAM), read-only memory (ROM), electrically erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

As used herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “module”, “model” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system, comprising:
a processor; and
memory storing an intelligent agent application that, when executed by the processor, causes the processor to execute the intelligent agent application and perform acts comprising:
receiving an intelligent agent deployment request, wherein the intelligent agent deployment request comprises one or more tasks to be executed by an intelligent agent;
deploying an intelligent agent to interact with a testing computing system, wherein the testing computing system is executing a video game application;
causing the intelligent agent to interact with the video game application and execute a first task of the one or more tasks;
obtaining testing data from the intelligent agent, wherein the testing data is indicative of the execution of the first task; and
storing the testing data at a data store.

2. The computing system of claim 1, further comprising:
enhancing the testing data by providing the testing data as input into at least one model, wherein responsive to receiving the testing data as input, the at least one model generates an output comprising enhanced testing data.

3. The computing system of claim 2, wherein the at least one model is at least one of: a generative model, a bug detector model, or an object detection model.

4. The computing system of claim 2, further comprising:
providing the enhanced testing data as input into a bug detector model, wherein the bug detector model generates an output indicative of at least one of a visual level of detail discontinuity, a missing texture, or an incorrectly applied texture.

5. The computing system of claim 1, further comprising:
providing the testing data as input into a first model, wherein responsive to receiving the testing data as input, the first model generates an output comprising first enhanced testing data; and
providing the enhanced testing data as input into a second model, wherein responsive to receiving the enhanced testing data as input, the first model generates an output comprising second enhanced testing data.

6. The computing system of claim 1, further comprising:
prior to deploying the intelligent agent, obtaining the intelligent agent from an intelligent agent data store storing a plurality of intelligent agents, wherein the intelligent agent is selected based upon the intelligent agent deployment request.

7. The computing system of claim 6, further comprising:
subsequent to obtaining the intelligent agent from the intelligent agent data store, modifying the intelligent agent based upon input received by way of a user interface executing on a client computing device.

8. The computing system of claim 1, wherein the intelligent agent performs a second task based upon execution of the first task.

9. The computing system of claim 1, further comprising:
providing the testing data as input into a intelligent agent task model, wherein the intelligent agent task model generates an output indicative of a second task to be performed based upon the testing data; and
causing the intelligent agent to execute the second task.

10. The computing system of claim 1, wherein the intelligent agent interacts with the video game application by way of providing input to the video game application, the provided input comprising input selected from the group consisting of input from an emulated controller, input from an emulated sensor, input from an emulated keyboard, and input from an emulated mouse.

11. A method, the method comprising:
receiving an intelligent agent deployment request, wherein the intelligent agent deployment request comprises one or more tasks to be executed by an intelligent agent;
deploying an intelligent agent to interact with a testing computing system, wherein the testing computing system is executing a video game application;
causing the intelligent agent to interact with the video game application and perform a first task of the one or more tasks;
obtaining testing data from the intelligent agent, wherein the testing data is indicative of the execution of the first task; and
storing the testing data at a data store.

12. The method of claim 10, further comprising:
enhancing the testing data by providing the testing data as input into at least one model, wherein, responsive to receiving the testing data as input, the at least one model produces and output comprising enhanced testing data.

13. The method of claim 11, wherein the at least one model is at least one of: a generative model, a bug detector model, or an object detection model.

14. The method of claim 10, further comprising:
prior to deploying the intelligent agent, obtaining the intelligent agent from an intelligent agent data store storing a plurality of intelligent agents, wherein the intelligent agent is selected based upon the intelligent agent deployment request.

15. The method of claim 14 further comprising:
subsequent to obtaining the intelligent agent from the intelligent agent data store, modifying the intelligent agent based upon input received by way of a user interface execution on a client computing device.

16. The method of claim 11, wherein the intelligent agent performs a second task based upon the execution of the first task.

17. The method of claim 11, further comprising:
providing the testing data as input into an intelligent agent task model, wherein the intelligent agent task model generates an output indicative of a second task to be performed based upon the testing data; and
causing the intelligent agent to execute the second task.

18. The method of claim 11, wherein the intelligent agent interacts with the video game application by way of providing input to the video game application, the provided input comprising input selected from the group consisting of input from an emulated controller, input from an emulated sensor, input from an emulated keyboard, and input from an emulated mouse.

19. A computer-readable storage medium comprising instructions that, when executed by a processor of a computing system, cause the processor to perform acts comprising:
receiving an intelligent agent deployment request, wherein the intelligent agent deployment request comprises one more tasks to be executed by an intelligent agent;
deploying an intelligent agent to interact with a testing computing system, wherein the testing computing system is executing a video game application;
causing the intelligent agent to interact with the video game application and perform a first task of the one or more tasks;
obtaining testing data from the intelligent agent, wherein the testing data is indicative of the execution of the first task; and
storing the testing data at a data store.

20. The non-transitory computer-readable storage medium of claim 19, further comprising:
enhancing the testing data by providing the testing data as input into at least one model, wherein, responsive to receiving the testing data as input, the at least one model produces and output comprising enhanced testing data.
